(19) United States
(12) Patent Application Publication
(10) Pub. No.: US 2012/0235058 A1
(43) Pub. Date: Sep. 20, 2012

(54) METHOD FOR EXTENDING LIFETIME OF AN ION SOURCE

(76) Inventors: Ashwini SINHA, East Amherst, NY (US); Lloyd A. BROWN, East Amherst, NY (US)

(21) Appl. No.: 13/229,939

(22) Filed: Sep. 12, 2011

Related U.S. Application Data
(60) Provisional application No. 61/383,213, filed on Sep. 15, 2010.

(51) Int. Cl. H01J 27/02

(52) U.S. Cl. 250/424

(57) ABSTRACT

This invention relates in part to a method for preventing or reducing the formation and/or accumulation of deposits in an ion source component of an ion implanter used in semiconductor and microelectronic manufacturing. The ion source component includes an ionization chamber and one or more components contained within the ionization chamber. The method involves introducing into the ionization chamber a dopant gas, wherein the dopant gas has a composition sufficient to prevent or reduce the formation of fluorine ions/radicals during ionization. The dopant gas is then ionized under conditions sufficient to prevent or reduce the formation and/or accumulation of deposits on the interior of the ionization chamber and/or on the one or more components contained within the ionization chamber. The deposits adversely impact the normal operation of the ion implanter causing frequent down time and reducing tool utilization.

### RELATED APPLICATIONS

The present application claims priority to U.S. Application Ser. No. 61/383,213, filed Sep. 15, 2010, which is incorporated by reference herein in its entirety.

### FIELD OF THE INVENTION

This invention relates in part to a method for preventing or reducing the formation and/or accumulation of deposits in an ion source component of an ion implanter used in semiconductor and microelectronics manufacturing. The ion source component includes an ionization chamber and one or more components contained within the ionization chamber. The deposits adversely impact the normal operation of the ion implanter causing frequent down time and reducing tool utilization.

### BACKGROUND OF THE INVENTION

Ion implantation is an important process in semiconductor/microelectronics manufacturing. The ion implantation process is used in integrated circuit fabrication to introduce dopant impurities into semiconductor wafers. The desired dopant impurities are introduced into semiconductor wafers to form doped regions at a desired depth. The dopant impurities are selected to bond with the semiconductor wafer material to create electrical carriers and thereby alter the electrical conductivity of the semiconductor wafer material. The concentration of dopant impurities introduced determines the electrical conductivity of the doped region. Many such impurity regions are necessarily created to form transistor structures, isolation structures and other electronic structures, which collectively function as a semiconductor device.

In an ion implantation process, a dopant source material, e.g., gas, is used that contains the desired dopant element. Referring to FIG. 3, the gas is introduced into an ion source chamber, i.e., ionization chamber, and energy is introduced into the chamber to ionize the gas. The ionization creates ions that contain the dopant element. An ion extraction system is used to extract the ions from the ion source chamber in the form of an ion beam of desired energy. Extraction can be carried out by applying a high voltage across extraction electrodes. The beam is transported through a mass analyzer/filter to select the species to be implanted. The ion beam can then be accelerated/decelerated and transported to the surface of a target workpiece positioned in an end station for implantation of the dopant element into the workpiece. The workpiece may be, for example, a semiconductor wafer or similar target object requiring ion implantation. The ions of the beam collide with and penetrate the surface of the workpiece to form a region with the desired electrical and physical properties.

A problem with the ion implantation process involves the formation and/or accumulation of deposits on the surfaces of the ion source chamber and on components contained within the ion source chamber. The deposits interfere with the successful operation of the ion source chamber, for example, electrical short circuits caused from deposits formed on low voltage insulators in the ion source chamber and energetic high voltage sparking caused from deposits formed on insulators in the ion source chamber. The deposits can adversely impact the normal operation of the ion implanter, cause frequent downtime and reduce tool utilization. Safety issues can also arise due to the potential for emission of toxic or corrosive vapors when the ion source chamber and components contained within the ion source chamber are removed for cleaning. It is therefore necessary to minimize or prevent formation and/or accumulation of deposits on the surfaces of the ion source chamber and components contained within the ion source chamber, thereby minimizing any interference with the successful operation of the ion source chamber.

Deposits are formed in the ion source chamber and nearby regions of an ion implantation tool while using SiF₄ as a dopant source. The deposits occur when fluorine ions/radicals formed from the dissociation of SiF₄ during ionization in the ion source chamber react with chamber material, predominantly tungsten, to produce volatile tungsten fluorides (WFₓ). These volatile fluorides migrate to hotter regions in the chamber and deposit as W. The chamber components where deposits are commonly formed include cathode, repeller electrode and regions close to the filament. FIG. 1 below shows a schematic illustrating various components of an IHC ion source.

Accumulation of material on the cathode reduces its thermionic emission rate, rendering it difficult to ionize the source gas. Also, excessive deposits on these components cause electrical shorting resulting in momentary drops in beam current and interruptions in operation of the ion source. Deposits are also formed on the aperture plate of the ion source chamber which degrades the uniformity of extracted ion beam. This region is also very sensitive due to its proximity to the suppression electrodes. Suppression electrodes are usually subjected to high voltage load (up to ±30 kV) and deposits in this region make them highly susceptible to electrical shorting.

The failure of an ion source may occur due to any or the combination of the mechanisms listed above. Once the ion source fails, implant users have to stop the processing, physically open the ion source chamber and clean or replace various components in the chamber. Besides the cost of cleaning or replacing the chamber components, this operation leads to significant amount of tool downtime and reduces tool utilization. Implant users will gain significant productivity improvements by preventing or reducing the formation and/or accumulation of such deposits, thereby extending the lifetime of an ion source.

Therefore, a need exists for preventing or reducing the formation and/or accumulation of deposits on the surfaces of the ion source chamber and components contained within the ion source chamber. It would be desirable in the art to develop methods for preventing or reducing the formation and/or accumulation of deposits on the surfaces of the ion source chamber and components contained within the ion source chamber so as to minimize any interference with the successful operation of the ion source chamber, thereby extending the lifetime of the ion source.

### SUMMARY OF THE INVENTION

This invention relates in part to a method for preventing or reducing the formation and/or accumulation of deposits in an ion source component of an ion implanter, wherein the ion source component comprises an ionization chamber and one or more components contained within the ionization chamber, the method comprising:

introducing into the ionization chamber a dopant gas, wherein the dopant gas has a composition sufficient to prevent or reduce the formation of fluorine ions/radicals during ionization; and

ionizing the dopant gas under conditions sufficient to prevent or reduce the formation and/or accumulation of deposits on the interior of the ionization chamber and/or on the one or more components contained within the ionization chamber.

This invention also relates in part to a method for the implantation of ions into a target, the method comprising:

a) providing an ion implanter having an ion source component, wherein the ion source component comprises an ionization chamber and one or more components contained within the ionization chamber;

b) providing an ion source reactant gas for providing a source of ion species to be implanted, wherein the ion source reactant gas has a composition sufficient to prevent or reduce the formation of fluorine ions/radicals during ionization;

c) introducing the ion source reactant gas into the ionization chamber;

d) ionizing the ion source reactant gas in the ionization chamber under conditions sufficient to prevent or reduce the formation and/or accumulation of deposits on the interior of the ionization chamber and/or on one or more components contained within the ionization chamber, to form ions to be implanted; and

e) extracting the ions to be implanted from the ionization chamber and directing them to the target, e.g., workpiece.

The method of this invention further relates in part to a method for extending the lifetime of an ion source component in an ion implanter, wherein the ion source component comprises an ionization chamber and one or more components contained within the ionization chamber, the method comprising:

a) introducing into the ionization chamber a dopant gas, wherein the dopant gas has a composition sufficient to prevent or reduce the formation of fluorine ions/radicals during ionization; and

b) ionizing the dopant gas under conditions sufficient to prevent or reduce the formation and/or accumulation of deposits on the interior of the ionization chamber and/or on the one or more components contained within the ionization chamber.

The method of this invention provides for improved prevention or reduction of the formation and/or accumulation of deposits on an ion source component of an ion implanter in comparison to other known processes such as SiF₄ based processes for ion implantation. The implementation of the method of this invention can enable customers to reduce the mean time between failure (MTBF) of the ion source of an ion implanter and to perform the desired ion implantation for longer periods of time, before cleaning of the ion source in an ion implanter is needed, and hence can improve tool utilization. Thus, the users can reduce tool downtime and safety concerns experienced during cleaning and component replacement.

Still other objects and advantages of this invention will become readily apparent to those skilled in the art from the following detailed description. This invention is capable of other and different embodiments, and its several details are capable of modifications in various obvious respects, without departing from the invention. Accordingly, the drawings and description are to be regarded as illustrative in nature and not as restrictive.

### BRIEF DESCRIPTION OF THE DRAWINGS

FIG. 1 is a schematic representation of an IHC (Indirectly Heated Cathode) ion source.

FIG. 2 is a table showing dissociation mechanism (lowest energy route) and dissociation energy for different Si-halides (Prascher et al., Chem Phy, (359), 2009 pp: 1-13).

FIG. 3 is a schematic representation of an ion implant system.

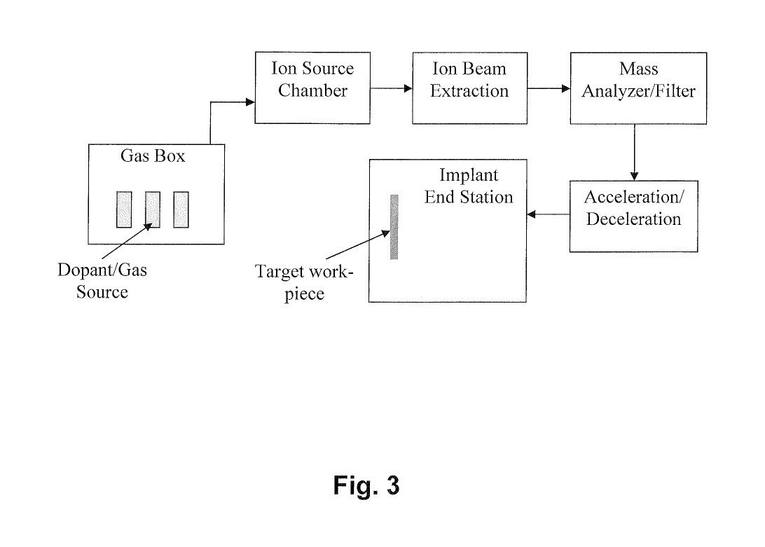

### DETAILED DESCRIPTION OF THE INVENTION

This invention relates to a process for implanting ions into a workpiece that improves or extends the ion source life of the ion implanter. Moreover, the process of this invention provides for improved life of the ion implanter source without a concomitant loss in throughput of the apparatus.

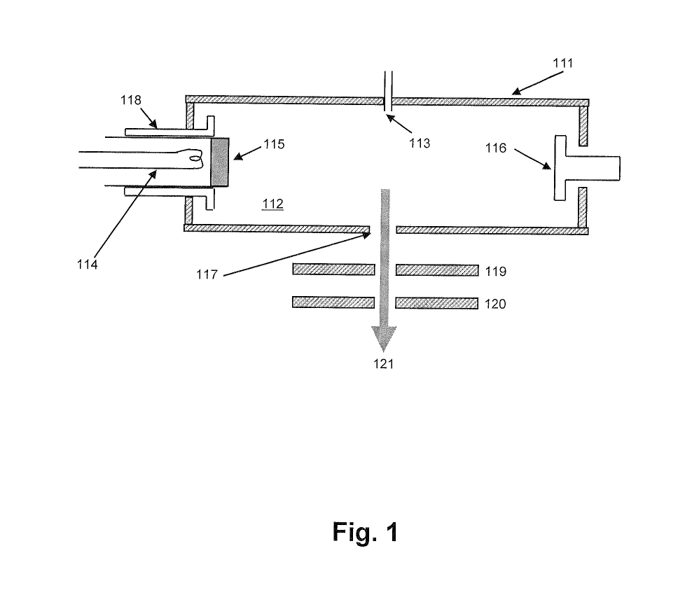

This invention is useful in the operation of ion implanters using heated cathode type ion source, such as the IHC (Indirectly Heated Cathode) ion source shown in FIG. 1. The ion source shown in FIG. 1 includes an arc chamber wall 111 defining the arc chamber 112. In the operation of the implanter, a source gas is introduced into the source chamber. The gases can be introduced into the source chamber, for example, through gas feed 113 at the side of the chamber. The ion source includes a filament 114. The filament typically is a tungsten-containing filament. For example, the filament may include tungsten or a tungsten alloy containing at least 50% tungsten. A current is applied to the filament 114 through an associated power supply to resistively heat the filament. The filament indirectly heats the cathode 115 positioned in close proximity to thermionic emission temperatures. An insulator 118 is provided to electrically isolate the cathode 115 from the arc chamber wall 111.

Electrons emitted by the cathode 115 are accelerated and ionize gas molecules provided by gas feed 113 to produce a plasma environment. The repeller electrode 116 builds up a negative charge to repel the electrons back to sustain ionization of gas molecule and the plasma environment in the arc chamber. The arch chamber housing also includes an extraction aperture 117 to extract the ion beam 121 out of the arc chamber. The extraction system includes extraction electrode 120 and suppression electrode 119 positioned in front of the extraction aperture 117. Both the extraction and suppression electrodes have an aperture aligned with the extraction aperture for extraction of a well defined beam 121 to be used for ion implantation. The lifetime of the ion source described above when operating with fluorine containing dopant gas such as SiF₄, GeF₄ and BF₃ etc. may be limited by metallic growth of W on arc chamber components exposed to the plasma environment containing highly active F ions.

This invention is not limited to the IHC type ion source shown in FIG. 1. Other suitable ion sources, for example, Bernas of Freeman type ion sources, may be useful in the operation of this invention. Additionally, this invention is not limited to the use of any one type of ion implantation apparatus. Instead the method of this invention is applicable for use with any type of ion implantation apparatus known in the art.

According to this invention, a gas or source material is introduced into the ion source chamber shown in FIG. 1. The gas may be introduced into the source chamber in controlled quantities so as to generate the desired ions to be implanted. As indicated above, certain source gases may cause formation and/or accumulation of deposits on the surfaces of the ion source chamber and components contained within the ion source chamber, e.g., the removal of tungsten from the source chamber walls and deposition of tungsten on other regions including but not limited to the filament, cathode, aperture and repeller. These deposits adversely impact the normal operation of the ion implanter, cause frequent downtime and reduce tool utilization.

In accordance with this invention, a method is provided for preventing or reducing the formation and/or accumulation of deposits on an ion source component of an ion implanter, wherein the ion source component comprises an ionization chamber and one or more components contained within the ionization chamber. The method comprises introducing into the ionization chamber a dopant gas, wherein the dopant gas has a composition sufficient to prevent or reduce the formation of fluorine ions/radicals during ionization. The dopant gas is then ionized under conditions sufficient to prevent or reduce the formation and/or accumulation of deposits on the interior of the ionization chamber and/or on the one or more components contained within the ionization chamber.

In particular, this invention provides a method for improving performance and extending lifetime of an ion source that generates at least silicon containing ions from a dopant precursor, e.g., dopant gas, wherein no diluent gas is introduced into the ion chamber simultaneously with the dopant gas. Only the dopant gas serves as the source of ionic species.

In accordance with this invention, a method is provided for extending the lifetime of an ion source component in an ion implanter, wherein the ion source component comprises an ionization chamber and one or more components contained within the ionization chamber. The method comprises introducing into the ionization chamber a dopant gas, wherein the dopant gas has a composition sufficient to prevent or reduce the formation of fluorine ions/radicals during ionization. The dopant gas is then ionized under conditions sufficient to prevent or reduce the formation and/or accumulation of deposits on the interior of the ionization chamber and/or on the one or more components contained within the ionization chamber.

Dopant sources include those having a composition sufficient to prevent or reduce the formation of fluorine ions/radicals during ionization. Illustrative dopant sources include, for example, dopant gases that comprise (i) a hydrogen containing fluorinated composition, (ii) a hydrocarbon containing fluorinated composition, (iii) a hydrocarbon containing hydride composition, (iv) a halide containing composition other than a fluorinated composition, or (v) a halide containing composition comprising a fluorine and a non-fluorine containing halide. In particular, dopant gases can be selected from monofluorosilane (SiH₃F), difluorosilane (SiH₂F₂), trifluorosilane (SiHF₃), monochlorosilane (SiH₃Cl), dichlorosilane (SiH₂Cl₂), trichlorosilane (SiCl₃H), silicon tetrachloride (SiCl₄), dichlorodisilane (Si₂Cl₂H₄), difluoromethane (CH₂F₂), trifluoromethane (CHF₃),), chloromethane (CH₃Cl), dichloromethane (CH₂Cl₂), trichloromethane (CHCl₃), carbon tetrachloride (CCl₄), monomethylsilane (Si(CH₃)H₃), dimethylsilane (Si(CH₃)₂H₂) and trimethylsilane (Si(CH₃)₃H), chlorotrifluoromethane (CClF₃), dichlorodifluoromethane (CCl₂F₂), trichlorofluoromethane (CCl₃F), bromotrifluoromethane (CBrF₃), and dibromodifluoromethane (CBr₂F₂), and the like.

Illustrative hydrogen containing fluorinated compositions include, for example, monofluorosilane (SiH₃F), difluorosilane (SiH₂F₂), trifluorosilane (SiHF₃), and the like.

Illustrative hydrocarbon containing fluorinated compositions include, for example, difluoromethane (CH₂F₂), trifluoromethane (CHF₃), and the like.

Illustrative hydrocarbon containing hydride compositions include, for example, monomethylsilane (Si(CH₃)H₃), dimethylsilane (Si(CH₃)₂H₂) and trimethylsilane (Si(CH₃)₃H), and the like.

Illustrative halide containing compositions other than fluorinated compositions include, for example, monochlorosilane (SiH₃Cl), dichlorosilane (SiH₂Cl₂), trichlorosilane (SiCl₃H), silicon tetrachloride (SiCl₄), dichlorodisilane (Si₂Cl₂H₄), chloromethane (CH₃Cl), dichloromethane (CH₂Cl₂), trichloromethane (CHCl₃), carbon tetrachloride (CCl₄), and the like.

Illustrative halide containing compositions comprising a fluorine and a non-fluorine containing halide include, for example, chlorotrifluoromethane (CClF₃), dichlorodifluoromethane (CCl₂F₂), trichlorofluoromethane (CCl₃F), bromotrifluoromethane (CBrF₃), and dibromodifluoromethane (CBr₂F₂), and the like.

Hydrogen containing fluorinated compositions reduce the amount of F per molecule and also generates H ions/radicals upon ionization. H ions/radicals react with the generated F ions/radicals to further reduce fluorine attack on the chamber component and extend the ion source life. The hydrogen containing fluorinated compositions maintain the same number of dopant atoms, e.g., Si, per unit gas flow as compared to undiluted SiF₄.

Halide containing compositions (e.g., chlorinated compositions) other than fluorinated compositions completely substitute F atoms with Cl atoms. They produce Cl ions or radicals upon dissociation. Cl ions or radicals produce WClₓ upon reaction with W which is significantly less volatile than corresponding WFₓ produced during reaction of F ions or radicals with W. For example, vapor pressure of WF₆ at 20° C. is 925 torr, whereas WCl₆ is a solid at 20° C. and even at 180° C., its vapor pressure is only 2.4 ton. Due to the significantly lower volatility of etch products in Cl environment in comparison to F environment, Cl does not etch W as readily as F, thus producing less amounts of volatile WClₓ. A reduced amount of volatile tungsten halide results in less deposition of W, thereby extending the life of the ion source.

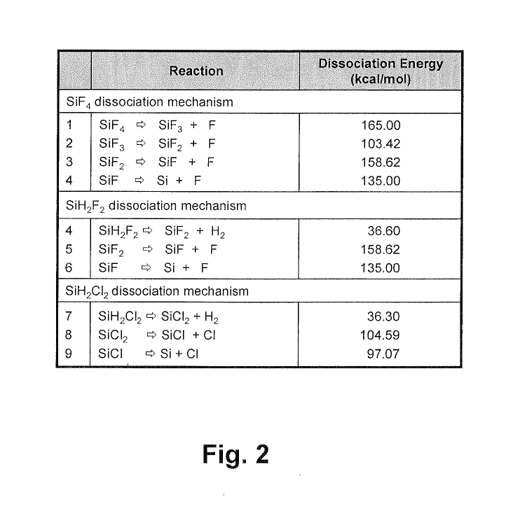

Also, for example in the case of Si containing dopant gas, less energy is required to dissociate a Si—Cl and Si—H bond in comparison to a Si—F bond. See FIG. 2. Hence, users can operate the ion source at reduced load (i.e., lower filament current and arc voltage) in comparison to SiF₄ to obtain similar Si beam current. This also helps extend the lifetime of the ion source.

Dischlorodisilane has two Si atoms per molecule. The use of this molecule can offer an added advantage of further increasing the Si beam current for the same amount of gas flow. Increased beam current provides an opportunity for reducing the cycle time to process wafers.

The dopants useful in this invention can be used without a diluent gas which serves as a source of ions.

The deposits formed during implantation typically contain tungsten (W) in varying quantities depending upon the location in the process chamber. W is a common material of construction for ionization chambers and for components contained within the ionization chambers. The deposits may also contain elements from the dopant gas.

The methods discussed in the prior art rely on two mechanisms to reduce deposit formation. Inerts mixed with the implantation gas physically sputter the deposits formed and removes them while they are being formed. Additionally, as shown by this invention, hydrogen mixing reduces the concentration of active fluorine to mitigate fluorine attack on chamber components. Hydrogen reacts with F radicals/ions to form HF.

However, co-flowing any other gas with the implantation gas also physically dilutes the concentration of implantation gas in the mix and therefore the concentration of implant ions (e.g., Si) for a given flow of implantation gas is lower. This results in lower beam current available for ion implantation. The user has to process wafers longer in order to achieve similar amount of dose as the undiluted process. This increases the process cycle time, thus resulting in a reduced tool throughput rate. Hence, the overall performance of the ion implant tool is still compromised. The use of heavy atoms such as Xe, Kr, or As is also undesirable due to risk of cathode thinning under the action of heavy physical sputtering.

In contrast to these methods, this invention uses alternative dopants to solve the source lifetime problems faced with other dopants, e.g., SiF₄. In particular, this invention uses dopants that incorporate hydrogen into the dopant source composition. For example, for Si containing dopants, suitable dopant molecules useful in this invention include monofluorosilane (SiH₃F), difluorosilane (SiH₂F₂), trifluorosilane (SiHF₃), and the like. All these molecules produce H and F upon ionization. Hydrogen serves as F scavenger and reduces fluorine attack on the chamber components. Unlike prior art methods, the method of this invention does not dilute the implantation gas stream, thus maintaining the same number of dopant atoms, e.g., Si, per unit gas flow as compared to undiluted SiF₄.

In an embodiment, this invention uses chlorinated molecules as dopant source. Suitable dopant molecules for Si containing dopant source include, for example, monochlorosilane (SiH₃Cl), dichlorosilane (SiH₂Cl₂), trichlorosilane (SiCl₃H), silicon tetrachloride (SiCl₄), dichlorodisilane (Si₂Cl₂H₄), and the like. These molecules produce Cl atom upon ionization. W etches at slower rate under chlorine plasma compared to fluorine plasma. Hence, the removal of W from chamber wall and its migration to different locations in/near the source chamber is significantly reduced when using a chlorinated molecule as a dopant source. Also, there is no dilution of the implantation gas stream. Hence, users can achieve similar beam current as the undiluted SiF₄ process and yet achieve extended lifetime of the ion source.

Dilution leads to higher cycle time due to a less amount of dopant atoms (e.g., Si) available per unit gas flow. The method of this invention extends the lifetime of the ion source without any loss in cycle time. For methods that employ a diluent gas, an additional gas stick (flow control device, pressure monitoring device, valves and electronic interface) is required for each dilution gas. This invention eliminates the requirement of any additional gas stick and saves capital expense required to provide additional gas sticks. Further, bond dissociation energies indicate that a user can ionize the alternative dopant molecules of this invention using less energy compared to SiF₄. See FIG. 2.

A halide containing composition other than a fluorinated composition, e.g., chlorinated composition, is a preferred dopant due to complete replacement of fluorine atom from the source molecule and lower dissociation energy. A preferred dopant for use in this invention is dichlorosilane (DCS). Other preferred dopant sources that may be used to replace SiF₄ include, for example, Si(CH₃)H₃, Si(CH₃)₂H₂ and Si(CH₃)₃H.

In a preferred method of this invention, a controlled flow of DCS is supplied to the ion source chamber of the ion implantation tool. DCS can be packaged in a high pressure cylinder or a sub-atmospheric delivery package such as UpTime® sub-atmospheric delivery system. A sub-atmospheric package is a preferred mode for delivery of the gas due to its enhanced safety. The flow rate of DCS can range from 1-20 sccm, more preferably from 1-5 sccm. Commonly used ion sources in commercial ion implanters include Freeman and Bernas type sources, indirectly heated cathode sources and RF plasma sources. The ion source operating parameters including pressure, filament current and arc voltage, and the like, are tuned to achieve desired ionization of DCS. Ions, e.g., Si or Si containing positive ions, are extracted by providing negative bias to the extraction assembly and are filtered using a magnetic field. The extracted beam is then accelerated across an electric field and implanted in to the substrate.

As indicated above, this invention relates in part to a method for the implantation of ions into a target. The method comprises providing an ion implanter having an ion source component, wherein the ion source component comprises an ionization chamber and one or more components contained within the ionization chamber. An ion source reactant gas provides a source of ion species to be implanted. The ion source reactant gas has a composition sufficient to prevent or reduce the formation of fluorine ions/radicals during ionization. The ion source reactant gas is introduced into the ionization chamber. The ion source reactant gas is ionized in the ionization chamber to form ions to be implanted. The ionization is conducted under conditions sufficient to prevent or reduce the formation and/or accumulation of deposits on the interior of the ionization chamber and/or on one or more components contained within the ionization chamber. The ions to be implanted are then extracted from the ionization chamber and directed to the target, e.g., workpiece.

The ion implanter can be operated by conventional methods known in the art. One skilled in the art of semiconductor processing will realize that specific flow control devices (e.g., mass flow controllers (MFCs), pressure transducers, valves, and the like) and monitoring system calibrated for specific dopants are required for practical operation. In addition, tuning of implant process parameters including filament current, arc voltage, extraction and suppression voltages, and the like, is required to optimize the process using a particular dopant. The tuning scheme includes optimizing beam current and its stability to achieve desired dopant dose. Once the ion beam has been extracted, no changes in the downstream processes should be required.

Ionization conditions may vary greatly. Any suitable combination of such conditions may be employed herein that are sufficient to prevent or reduce the formation of deposits from the interior of the ionization chamber and/or from the one or more components contained within the ionization chamber. The ionization chamber pressure can range from about 0.1 to about 10 millitorr, preferably from about 0.5 to about 2.5 millitorr. The ionization chamber temperature can range from about 25° C. to about 1000° C., preferably from about 400° C. to about 600° C. The dopant gas flow rate can range from about 0.1 to about 20 sccm, more preferably from about 0.5 to about 3 sccm.

By employing the method of this invention, the lifetime of the ion source of the ion implanter can be extended. This represents an advance in the ion implantation industry since it reduces the shutdown time that would be required to repair or clean the tool.

The method of this invention is suitable for use in a wide range of applications, wherein ion implantation is required. The method of this invention is very applicable for use in the semiconductor industry to provide a semiconductor wafer, chip or substrate with source/drain regions, to pre-amorphize or for surface modification of the semiconductor wafer of substrate.

Various modifications and variations of this invention will be obvious to a worker skilled in the art and it is to be understood that such modifications and variations are to be included within the purview of this application and the spirit and scope of the claims.

1. A method for preventing or reducing the formation and/or accumulation of deposits in an ion source component of an ion implanter, wherein said ion source component comprises an ionization chamber and one or more components contained within said ionization chamber, said method comprising:
introducing into said ionization chamber a dopant gas, wherein said dopant gas has a composition sufficient to prevent or reduce the formation of fluorine ions/radicals during ionization; and
ionizing said dopant gas under conditions sufficient to prevent or reduce the formation and/or accumulation of deposits on the interior of said ionization chamber and/or on said one or more components contained within said ionization chamber.

2. The method of claim 1 wherein the dopant gas comprises (i) a hydrogen containing fluorinated composition, (ii) a hydrocarbon containing fluorinated composition, (iii) a hydrocarbon containing hydride composition, (iv) a halide containing composition other than a fluorinated composition, or (v) a halide containing composition comprising a fluorine and a non-fluorine containing halide.

3. The method of claim 1 wherein the dopant gas comprises a hydrogen containing fluorinated composition selected from monofluorosilane (SiH₃F), difluorosilane (SiH₂F₂), and trifluorosilane (SiHF₃).

4. The method of claim 1 wherein the dopant gas comprises a hydrocarbon containing fluorinated composition selected from difluoromethane (CH₂F₂), and trifluoromethane (CHF₃).

5. The method of claim 1 wherein the dopant gas comprises a hydrocarbon containing hydride composition selected from monomethylsilane (Si(CH₃)H₃), dimethylsilane (Si(CH₃)₂H₂), and trimethylsilane (Si(CH₃)₃H).

6. The method of claim 1 wherein the dopant gas comprises a halide containing composition other than a fluorinated composition, said halide containing composition selected from monochlorosilane (SiH₃Cl), dichlorosilane (SiH₂Cl₂), trichlorosilane (SiCl₃H), silicon tetrachloride (SiCl₄), dichlorodisilane (Si₂Cl₂H₄), chloromethane (CH₃Cl), dichloromethane (CH₂Cl₂), trichloromethane (CHCl₃), and carbon tetrachloride (CCl₄).

7. The method of claim 1 wherein the dopant gas comprises a halide containing composition comprising a fluorine and a non-fluorine containing halide, said halide containing composition selected from chlorotrifluoromethane (CClF₃), dichlorodifluoromethane (CCl₂F₂), trichlorofluoromethane (CCl₃F), bromotrifluoromethane (CBrF₃), and dibromodifluoromethane (CBr₂F₂).

8. The method of claim 1 wherein said deposits comprise tungsten from said ionization chamber and/or from said one or more components contained within said ionization chamber.

9. The method of claim 1 wherein said method is carried out in the absence of a diluent gas.

10. The method of claim 1 wherein said method is carried out without reducing the concentration of ions to be implanted.

11. The method according to claim 1 wherein said ion source chamber includes walls made of tungsten-containing material.

12. The method of claim 1 further comprising extracting an ion beam from said ionization chamber for implantation into a substrate.

13. The method according to claim 12 wherein the substrate is a semiconductor wafer.

14. A method for the implantation of ions into a target, said method comprising:
a) providing an ion implanter having an ion source component, wherein said ion source component comprises an ionization chamber and one or more components contained within said ionization chamber;
b) providing an ion source reactant gas for providing a source of ion species to be implanted, wherein said ion source reactant gas has a composition sufficient to prevent or reduce the formation of fluorine ions/radicals during ionization;
c) introducing the ion source reactant gas into the ionization chamber;
d) ionizing the ion source reactant gas in the ionization chamber under conditions sufficient to prevent or reduce the formation and/or accumulation of deposits on the interior of said ionization chamber and/or on one or more components contained within said ionization chamber, to form ions to be implanted; and
e) extracting the ions to be implanted from said ionization chamber and directing them to said target.

15. The method of claim 14 wherein the ion source reactant comprises (i) a hydrogen containing fluorinated composition, (ii) a hydrocarbon containing fluorinated composition, (iii) a hydrocarbon containing hydride composition, (iv) a halide containing composition other than a fluorinated composition, or (v) a halide containing composition comprising a fluorine and a non-fluorine containing halide.

16. The method of claim 14 wherein the dopant gas comprises a hydrogen containing fluorinated composition selected from monofluorosilane (SiH₃F), difluorosilane (SiH₂F₂), and trifluorosilane (SiHF₃).

17. The method of claim 14 wherein the dopant gas comprises a hydrocarbon containing fluorinated composition selected from difluoromethane (CH₂F₂), and trifluoromethane (CHF₃).

18. The method of claim 14 wherein the dopant gas comprises a hydrocarbon containing hydride composition selected from monomethylsilane (Si(CH₃)H₃), dimethylsilane (Si(CH₃)₂H₂), and trimethylsilane (Si(CH₃)₃H).

19. The method of claim 14 wherein the dopant gas comprises a halide containing composition other than a fluorinated composition, said halide containing composition selected from monochlorosilane (SiH₃Cl), dichlorosilane (SiH₂Cl₂), trichlorosilane (SiCl₃H), silicon tetrachloride (SiCl₄), dichlorodisilane (Si₂Cl₂H₄), chloromethane (CH₃Cl), dichloromethane (CH₂Cl₂), trichloromethane (CHCl₃), and carbon tetrachloride (CCl₄).

20. The method of claim 14 wherein the dopant gas comprises a halide containing composition comprising a fluorine and a non-fluorine containing halide, said halide containing composition selected from chlorotrifluoromethane (CClF₃), dichlorodifluoromethane (CCl₂F₂), trichlorofluoromethane (CCl₃F), bromotrifluoromethane (CBrF₃), and dibromodifluoromethane (CBr₂F₂).

21. The method of claim 14 wherein said deposits comprise tungsten from said ionization chamber and/or from said one or more components contained within said ionization chamber.

22. The method of claim 14 wherein said method is carried out in the absence of a diluent gas.

23. The method of claim 14 wherein said method is carried out without reducing the concentration of ions to be implanted.

24. The method according to claim 14 wherein said ion source chamber includes walls made of tungsten-containing material.

25. The method according to claim 14 wherein said target is a semiconductor wafer.
